(19) United States
(12) Patent Application Publication
(10) Pub. No.: US 2025/0076898 A1
(43) Pub. Date: Mar. 6, 2025

(54) COLLECTION METHOD AND COLLECTION SYSTEM

(71) Applicant: MITSUBISHI HEAVY INDUSTRIES, LTD., Tokyo (JP)

(72) Inventors: Makoto HIRAI, Tokyo (JP); Ichiro OBA, Tokyo (JP); Hirofumi MAEDA, Tokyo (JP); Daisuke YAMAGUCHI, Tokyo (JP); Yohei TAKAYAMA, Tokyo (JP); Masashi YOSHIDA, Tokyo (JP)

(21) Appl. No.: 18/810,515

(22) Filed: Aug. 21, 2024

(30) Foreign Application Priority Data
Sep. 6, 2023 (JP) 2023-144152

(51) Int. Cl. G05D 1/683; G05D 105/28; G05D 109/25

(52) U.S. Cl. CPC G05D 1/683; G05D 2105/28; G05D 2109/254

(57) ABSTRACT

Regarding a method of collecting a target object falling through the air by using an unmanned aerial vehicle, the method including: an information transmission step of transmitting state information of the target object falling through the air from the target object; and a collection step of capturing the target object by an unmanned aerial vehicle flying in accordance with command information generated based on the state information.

### CROSS-REFERENCE TO RELATED APPLICATIONS

This application claims the benefit of priority to Japanese Patent Application Number 2023-144152 filed on Sep. 6, 2023. The entire contents of the above-identified application are hereby incorporated by reference.

### TECHNICAL FIELD

The present disclosure relates to a method of collecting a target object falling through the air by using an unmanned aerial vehicle (UAV).

### RELATED ART

Regarding an object such as a cargo or a structure dropped and falling from the sky, in order to collect the cargo or the structure without destroying it, the falling object is attached with a parachute or is attached with a cushioning member that absorbs impact of the falling. Alternatively, various techniques have been studied and achieved, such as a method in which the object fires an engine just before landing and collection, like a collection-type rocket.

Regarding a UAV that is an example of the target object, JP 2010-173401 A proposes the following collection method. That is, JP 2010-173401 A includes a step of providing a net placed horizontally on the ground and circling the UAV above this collection net, and a step of descending the aircraft from a leeward direction at a high attack angle and landing it on the collection net.

According to the collection method in JP 2010-173401 A, it is possible to descend the aircraft at a steep angle while being in a high attack angle state in which the aircraft raises its nose without receiving crosswind, and stably land the aircraft onto the surface of the collection net surface horizontally placed. That is, in JP 2010-173401 A, since the landing is not from horizontal flight, the area where the collection net is placed can be narrowed.

### SUMMARY

The UAV that is the target object to be collected in JP 2010-173401 A is assumed to have a propulsive force, and JP 2010-173401 A is not suitable for collecting an object having no propulsive force. That is, for example, an airflow acts on an object falling through the air, and thus, a falling route of the object, including a final falling position, may vary from moment to moment depending on weather conditions.

As described above, an object of the present disclosure is to provide a collection method capable of collecting a target object even if a falling route of the target object fluctuates. An object of the present disclosure is to provide a collection system capable of achieving such a collection method.

The present disclosure relates to a method of collecting a target object falling through the air by using an unmanned aerial vehicle.

The collection method of the present disclosure includes:
an information transmission step of transmitting state information of a target object falling through the air from the target object; and
a collection step of capturing the target object by an unmanned aerial vehicle flying in accordance with command information generated based on the state information.

The present disclosure relates to a system of collecting a target object falling through the air by using an unmanned aerial vehicle.

The collection system according to the present disclosure includes:
a state information generation unit that is provided in the target object and generates and transmits state information of the target object; and
a controller that is provided in the unmanned aerial vehicle, generates command information based on the state information, and controls flight of the unmanned aerial vehicle.

According to the present disclosure, the state information of the target object is transmitted from the target object to be collected, and an unmanned aerial vehicle flies in accordance with the command information generated based on this state information and captures the target object. Thus, according to the collection method of the present disclosure, the target object can be collected even if the falling route of the target object fluctuates.

### BRIEF DESCRIPTION OF DRAWINGS

The disclosure will be described with reference to the accompanying drawings, wherein like numbers reference like elements.

FIG. 1 is a diagram illustrating an outline of an article transport method including a collection method according to an embodiment.

FIG. 2 is a diagram illustrating a summary of a collection method according to an embodiment.

FIG. 3 is a diagram illustrating a summary of a collection method according to an embodiment.

FIG. 4 is a diagram illustrating a controller of a UAV in a collection method according to an embodiment.

FIG. 5 is a diagram explaining a procedure for generating command information in a collection method according to an embodiment.

FIG. 6 is a diagram illustrating a summary of a collection method according to another embodiment.

### DESCRIPTION OF EMBODIMENTS

A collection method and a collection system of an object according to an embodiment will be described below with reference to the accompanying drawings.

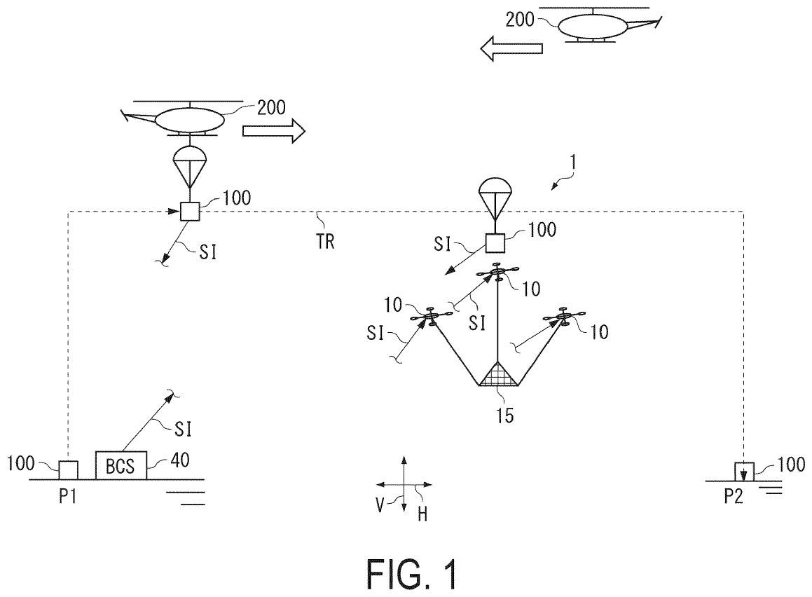

### Outline of Collection Method: See FIG. 1

The collection method according to the embodiment is performed as one process in the processes of transporting a target object. As illustrated in FIG. 1, in the transport method according to the embodiment, a target object 100 to be transported is transported from a transport source P1 to a transport destination P2. That is, the target object 100 is transported on a transport route TR from the transport source P1 to the transport destination P2. Note that the transport route TR illustrated in FIG. 1 is indicated by a line diagram for convenience of description, but the transport can be performed with the target object 100 deviating from the planned transport route TR by an allowable range.

The target object 100 departs from the transport source P1 in a state of being suspended from an aircraft 200. However, on the way of the transport route TR, the target object 100 is detached from the aircraft 200 and falls through the air. In the collection method according to the embodiment, the target object 100 falling through the air is collected by a collection system 1 including a plurality of UAVs 10, and the collection system 1 that completed the collection delivers the target object 100 to the transport destination P2. As described above, in the transport method according to the embodiment, a transport means is changed from the aircraft 200 to the collection system 1 between the transport source P1 and the transport destination P2. After detaching the target object 100, the aircraft 200 returns to the transport source P1, for example, and performs transport of the next target object 100. The collection system 1 is on standby at the transport destination P2, for example, takes off from the transport destination P2 at a necessary timing, and flies toward an area where the target object 100 is collected, in other words, a vicinity of a point where the target object 100 is separated from the aircraft 200. In this embodiment, the aircraft 200 suspends the target object 100 via a parachute 101, and at an appropriate location, the target object 100 is detached from the aircraft 200 and falls with the parachute 101. The target object 100 is attached with the parachute to reduce the falling speed, thereby making it easier for a capture tool 15 to capture the target object 100.

Note that the transport method according to the embodiment is effective in cases such as when there is no space where the aircraft 200 can land at the transport destination P2.

The UAV in the present disclosure refers to an aircraft having a structure that does not allow to carry a human and being capable of autonomous flight, and may be referred to as a drone.

Furthermore, the target object 100 in the present disclosure is not limited, and not only a solid that can be a transport target but also a gas and a liquid accommodated in a container can be the target object 100.

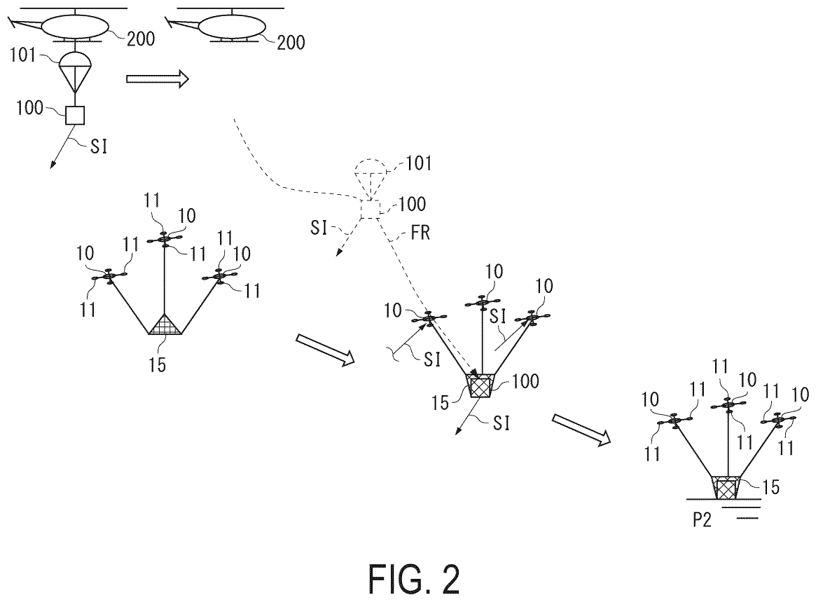

### Specific Collection Method: See FIGS. 1 and 2

Next, a specific example of the collection method of the target object 100 by the collection system 1 will be described.

As a specific example of the collection method, the aircraft 200, for example, a rotorcraft (helicopter), transports the target object 100 from the transport source P1 to a halfway point, and the collection system 1 collects the target object 100 detached from the aircraft 200 and performs transport of the target object 100 to the transport destination P2. Note that although an example in which the target object 100 is suspended from the aircraft 200 via the parachute 101 is illustrated, the target object 100 can also be supported not via the parachute 101 or another member. Although the target object 100 is suspended outside the aircraft 200 in this example, the target object 100 stored inside the aircraft 200 may be dropped outside the aircraft 200.

The target object 100 detached from the aircraft 200 falls through the air. Since the target object 100 is suspended with the parachute 101, the falling speed can be reduced compared with the target object 100 falling by itself. On the other hand, since the target object 100 receives an airflow, it is difficult to specify a falling route FR in advance. Thus, the target object 100 is provided with a state information generation unit 30 that can generate state information SI of the target object 100. The target object 100 falls through the air while transmitting the state information SI of its own (state information transmission step). The state information SI will be described later in detail.

The state information SI of the target object 100 transmitted from the target object 100 is received by each of the three UAVs 10 via a base station 40, for example. Each of the UAVs 10 generates command information CI for itself based on the received state information SI of the target object 100. Each of the UAVs 10 flies based on the generated command information CI. The UAV 10 is provided with a rotary blade 11, and specifically, the operation of the rotary blade 11 is controlled in accordance with the command information CI so that the target object 100 falling can be collected by capturing using the capture tool 15 supported by the three UAVs 10 (collection step). After capturing the target object 100, the target object 100 collected by the capture tool 15 is transported to the transport destination P2 while being towed by the three UAVs 10. Specific contents of the command information CI will be described later.

### Configuration of Collection System 1: See FIGS. 2 to 5

In order to achieve this collection method, the collection system 1 includes the state information generation unit 30 provided to the target object 100, and the base station (BCS) 40 that receives the state information SI transmitted from the state information generation unit 30. The base station 40 transmits the received state information SI to each of a plurality of UAVs 10, here, three UAVs 10 as an example, and the flight of the three UAVs 10 is controlled so as to collect the target object 100, based on the received state information SI.

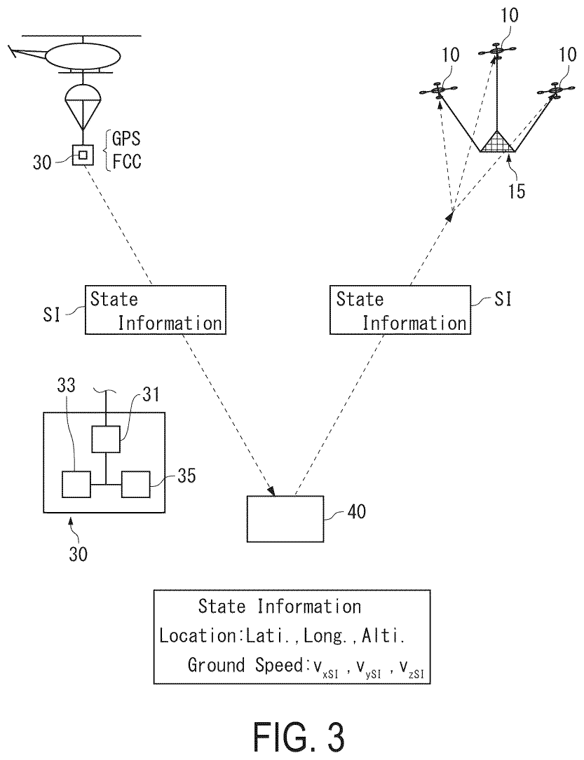

### State Information Generation Unit 30 Included in Target Object 100: See FIG. 3

The state information SI about the target object 100 includes information regarding the position of the target object 100 (position state information PS) and information regarding the speed (velocity state information VS).

The position state information PS and the velocity state information VS are generated using a global positioning system (GPS) as an example of a satellite positioning system. The state information generation unit 30 includes a communication unit 31 that receives radio waves from a GPS satellite and transmits the calculated state information SI, a GPS reception unit 33 that calculates position state information based on the radio waves received from the GPS satellite, and a velocity information generation unit 35 that obtains velocity information of the target object 100 by calculating based on the position state information calculated by the GPS reception unit 33.

Although the GPS is well known and thus will not be described in detail here, the GPS includes three elements of a GPS satellite (space segment), ground control (control segment) that performs maintenance of the GPS satellite as needed, and a GPS receiver (user segment) that receives radio waves from the GPS satellite and calculates the position. The state information generation unit 30 includes a GPS receiver and generates the position state information PS specifying the position of the target object 100. This position state information PS includes three elements of the latitude, the longitude, and the altitude. The state information generation unit 30 continuously calculates the position state information by continuously receiving radio waves from the GPS satellite.

Examples of the satellite of a Global Navigation Satellite System (GNSS) include, in addition to GPS, QZSS (Japan), GLONASS (Russia), and Galileo (EU), and any of them can be used.

The velocity state information VS indicates ground speed, and as an example, in the state information generation unit 30, the velocity information generation unit 35 calculates the ground speed of the target object 100 based on the velocity state information VS calculated by the GPS reception unit 33. Displacement of the target object 100 is calculated from the position state information of the target object 100 calculated by the GPS reception unit 33, the speed of the target object 100 is calculated by differentiating this displacement with time, and the acceleration of the target object 100 is calculated by differentiating the calculated speed with time. Note that the calculated speed is denoted as (vₓ, v_{y}, v_{z}) corresponding to the three pieces of position state information (latitude, longitude, and altitude). The same applies to acceleration, which is denoted as (aₓ, a_{y}, a_{z}).

The position state information obtained by the GPS reception unit 33 and the velocity information obtained by the velocity information generation unit 35 are transmitted from the communication unit 31 to each of the UAVs 10.

### Base Station 40: FIGS. 1 and 3

The base station 40 is provided at a fixed location on the ground as an example, and receives the state information SI of the target object 100 generated by the state information generation unit 30 provided in the target object 100. The base station 40 transfers the received state information SI to each of the three UAVs 10. The base station 40 can provide other information to the UAV 10, in addition to transferring the state information SI but also. The number of the base station 40 may be one, or may be multiple, for example, due to the long distance from the transport source PI to the transport destination P2. Note that the state information SI generated by the target object 100 can be directly transmitted to the UAV 10.

Note that the presence of the base station 40 is optional in the present disclosure. Thus, when the base station 40 is not present, the state information SI from the target object 100 is transmitted from the state information generation unit 30 directly to the UAV 10.

### UAV 10: See FIGS. 2 to 4

The UAV 10 receives the state information SI transmitted from the base station 40 and flies based on the command information CI generated based on the received state information SI. Note that the UAV 10 flies based on the command information CI at least when involved in collection of the target object 100, and may fly based on information different from the command information CI at other times. For example, until involved in collection of the target object 100, the UAV 10 may fly by collating the information regarding the predetermined transport route TR with the position state information calculated by a GPS reception unit 29 provided in the UAV 10. The same applies to the case of transporting the target object 100 to the transport destination P2 after finishing collection of the target object 100.

The three UAVs 10 are on standby at the transport destination P2, for example, and can take off for collection of the target object 100 when the aircraft 200 reaches a predetermined detachment area. As another example, the three UAVs 10 are on standby in the vicinity of the predetermined detachment area, and can take off for collection of the target object 100 when the aircraft 200 reaches the predetermined detachment area.

As an example, the three UAVs 10 support the capture tool 15 for capturing the target object 100. In the embodiment, a net for capturing is used as the capture tool 15. The three UAVs 10 fly while supporting the capture net in an expanded state as the capture tool 15 with equal distance in a horizontal direction H, for example. The number of UAVs 10 supporting the capture tool 15 is not limited to three, but may be selected from one or more than two. The weight of the target object 100 to be collected and transported is one of the factors that affect the number of UAVs 10. Note that although it is difficult to hold the illustrated net with only one UAV 10, if the net is, for example, a dip net having a handle and being capable of maintaining the form of the part of the net, one UAV 10 can hold the part of the handle and capture the target object 100.

The UAV 10 is in any form as long as it can fly autonomously according to the generated command information CI. Typically, the UAV 10 including the rotary blades 11 at a plurality of locations is used. More specifically, a tricopter with three rotary blades, a quadcopter with four rotary blades, a hexacopter with six rotary blades, or the like may be applied. The greater the number of rotary blades, the higher stability during flight tends to be, but the weight of the UAV 10 increases accordingly, and the number of maintenance locations also increases. The UAV 10 to be used may be selected in consideration of these matters and the weight of the target object 100 to be collected and transported.

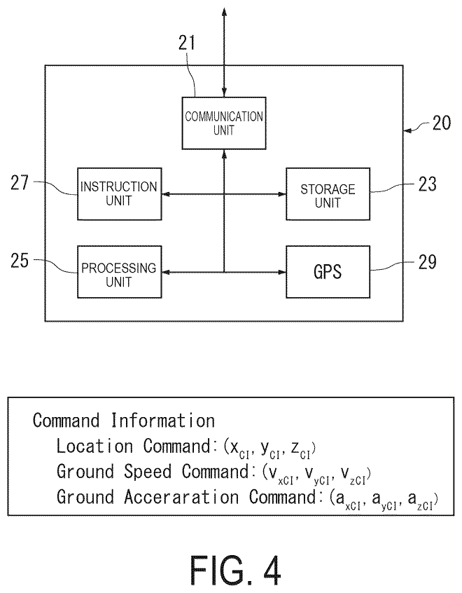

Each of the UAVs 10 includes a controller 20 for generating the command information CI based on the transmitted state information SI. As illustrated in FIG. 4, the controller 20 includes a communication unit 21, a storage unit 23, a processing unit 25, and an instruction unit 27. The controller 20 can include the GPS reception unit 29. The GPS reception unit 29 has a function similar to that of the GPS reception unit 33, and can specify the state information of the UAV 10.

The controller 20 includes a computer device, and includes, for example, a Central Processing Unit (CPU), a Random Access Memory (RAM), a Read Only Memory (ROM), and a computer-readable storage medium. Then, a series of processing for achieving various functions is stored in the storage unit 23 in the form of a program, for example, and the CPU reads out this program to the processing unit 25 including a RAM and executes process and arithmetic processing of information, thereby achieving the various functions.

Note that the program may be applied with a form of being installed in advance in a ROM or another storage medium, a form of being provided in a state of being stored in a computer-readable storage medium, a form of being distributed via a wired or wireless communication means, or the like.

Examples of the computer-readable storage medium include a magnetic disk, a magneto-optical disk, a CD-ROM, a DVD-ROM, a semiconductor memory, and the like.

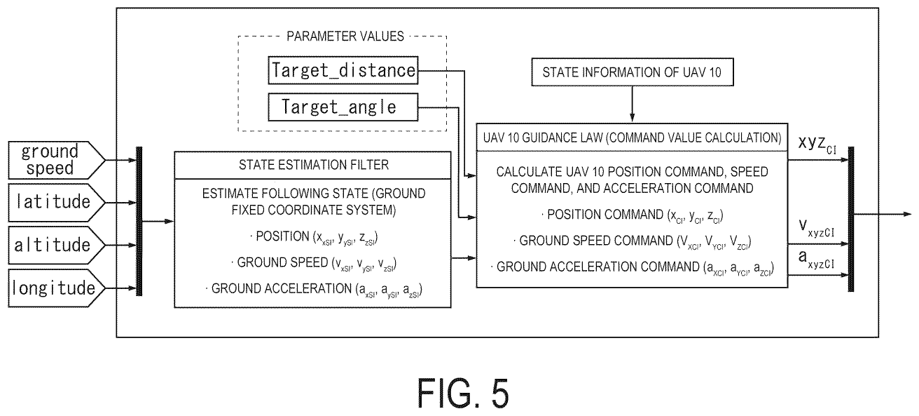

The communication unit 21 receives the state information SI transmitted from the state information generation unit 30 of the target object 100, and the received state information SI is transferred to and stored in the storage unit 23. The processing unit 25 reads the state information SI stored in the storage unit 23 and generates the command information CI. The storage unit 23 stores information such as a state estimation filter necessary for generating the command information CI from the state information SI, and the processing unit 25 reads the state estimation filter and the like from the storage unit 23 and generates the command information CI. The generated command information CI is sent to the instruction unit 27, and the instruction unit 27 commands the drive source of the UAV 10 to operate, based on the command information CI. An example of a procedure for generating the command information CI particularly in the processing unit 25 of the controller 20 will be described with reference to FIG. 5. Note that in a part of FIG. 5, the target object 100, which is a target object, is denoted as Target.

In order to generate the command information CI, the position state information PS and the velocity state information VS, which are the state information SI of the target object 100, are given. This state information SI is transmitted from the base station 40. The position state information PS corresponds to the latitude, the longitude, and the altitude. The velocity state information VS corresponds to the ground speed. The command information CI is obtained by processing the position state information PS and the velocity state information VS.

The command information CI includes ground position command information xyz_{CI}, ground speed command information v_{CI}, and ground acceleration command information a_{CI}. These pieces of command information CI are transmitted to the instruction unit 27, and the instruction unit 27 drives the drive source of the rotary blade 11 based on the command information CI.

When the state information SI is given, the state of the target object 100 is estimated as follows via the state estimation filter.
Ground position state information (x_{SI}, y_{SI}, z_{SI})
Ground state speed information (v_{xSI}, v_{ySI}, _{zSI})
Ground state acceleration information (a_{xSI}, a_{ySI}, a_{zSI})

In order to generate the command information CI, in addition to the state information SI, two parameter values regarding the target object 100, which is the target object, are also referred to.

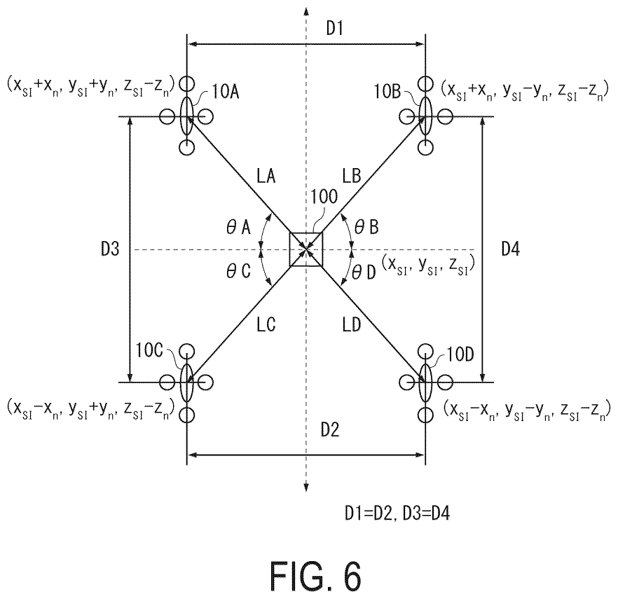

Target_distance: The distance from the UAV 10 to the target object 100 (LA to LD; See FIG. 6)

Target_angle: The angle formed by the UAV 10 and the target object 100 (θA to θD; See FIG. 6)

In order to generate the command information CI, the state information specified by the GPS reception unit 29 of the controller 20 can also be used.

The command information CI, which is a guidance law of the UAV 10 as a collector, is calculated from the estimation information of the target object 100, the parameter values, and the state information of the UAV 10. The command information CI includes the following three elements. The state information of the UAV 10 includes the position state information and the velocity information as well as the state information SI.
Ground position command information xyz_{CI}: (x_{CI}, y_{CI}, z_{CI})
Ground speed command information v_{CI}: (v_{xCI}, v_{yCI}, v_{zCI})
Ground acceleration command information a_{CI}: (a_{xCI}, a_{yCI}, a_{zCI})

The three UAVs 10 fly by controlling the rotary blade 11 in accordance with the generated command information CI, and the capture tool 15 spread by the three UAVs 10 is disposed directly below the target object 100 to capture the target object 100. Thereafter, the target object 100 is transported to the transport destination P2 by any flight method. This control is feedback control (e.g., Proportional-Integral-Derivative Controller (PID control)) using the command information CI as a target value.

In the above example, the target object 100 to be transported is transported from the transport source P1 to the transport destination P2, but the present disclosure is not limited to this example. The collection method in the present disclosure is widely applied to a target object falling through the air other than being transported along a predetermined route. For example, a fairing detached from a rocket, a UAV without a landing gear, a UAV that has completed its mission and is dropped using a parachute, or the like can be a target object for collection.

In the above example, the command information CI is generated in the controller 20 of the UAV 10, but the present disclosure is not limited to this. For example, the base station 40 that receives the state information SI can have the function described with reference to FIG. 5, and can generate the command information CI. In this case, the state information obtained by the GPS reception unit 29 of the UAV 10 is transmitted to the base station 40.

### Effects Achieved by Collection System 1

The collection system 1 and the collection method performed by the collection system 1 according to the embodiment achieve the following effects.

Since the command information CI is generated based on the state information SI of the target object 100 falling through the air to fly the UAV 10, the target object 100 can be collected even if the falling route of the target object 100 fluctuates due to an airflow, for example.

The state information SI in the embodiment includes two types of information including the position state information PS of the target object 100 relative to the ground and the velocity state information VS of the target object 100 relative to the ground. Thus, since the flight of the UAV 10 is controlled based on these two types of information, the falling target object 100 can be collected with high accuracy.

Since the state information SI in the embodiment is generated based on radio waves received from a GPS satellite, it is possible to collect the falling target object 100 without providing special equipment.

The command information CI in the present embodiment includes three types of information including the position command information (xyz_{CI}) for the UAV 10 relative to the ground, the speed command information (v_{CI}) for the UAV 10 relative to the ground, and acceleration command information (a_{CI}) for the UAV 10 relative to the ground. Since the operation of each of the UAVs 10 is controlled based on these three types of information, even if the target object 100 is displaced, the UAVs 10 can quickly follow the target object 100.

The present embodiment allows the capture tool 15 supported by the UAV 10 to capture the target object 100. This facilitates capture of the target object 100. As the capture tool 15, a net-like tool is suitable, and the net-like capture tool 15 can capture the target object 100 while reducing the impact on the target object 100.

### Another Example of Command Information CI: FIG. 6

In the embodiment described above, the command information CI relative to the ground is exemplified, but the command information CI in the present disclosure is not limited to this example.

For example, as illustrated in FIG. 6, it is also possible to generate the command information CI so that the relative positions of the plurality of UAVs 10 with respect to the target object 100 are at a fixed distance from each other, and to control the flight of a plurality of UAVs, here, four UAVs 10A, 10B, 10C, and 10D as an example. This is equivalent to the relative positions of the plurality of UAVs 10A, 10B, 10C, and 10D with respect to the capture tool 15 being at a fixed distance from each other, and the target object 100 can be captured.

Assuming that the position state information of the target object 100 is (x_{SI}, y_{SI}, z_{SI}), if the flight of the UAVs 10A, 10B, 10C, and 10D is controlled by the position command information described below, the relative positions of the UAVs 10A, 10B, 10C, and 10D with respect to the target object 100 are at a fixed distance from each other, and the capture tool 15 can preferably be disposed directly below the target object 100. Specifying the position in a vertical direction V (z_{SI}-zₙ) ensures that the capture tool 15 is positioned below the target object 100, but in order to capture the target object 100, zₙ is finally set to zero. That is, xₙ and yₙ may have fixed values, but zₙ needs to be fluctuated. However, xₙ and yₙ are not necessarily fixed values, and xₙ and yₙcan be returned assuming that xₙ and yₙ are the same values for the UAVs 10A, 10B, 10C, and 10D.
UAV 10A: (x_{SI}+xₙ, y_{SI}+yₙ, z_{SI}−zₙ)
UAV 10B: (x_{SI}+xₙ, y_{SI}−yₙ, z_{SI}−zₙ)
UAV 10C: (x_{SI}−xₙ, y_{SI}+yₙ, z_{SI}−zₙ)
UAV 10D: (x_{SI}−xₙ, y_{SI}−yₙ, z_{SI}−zₙ)

In this case, as illustrated in FIG. 6, group control may be further added so that the mutual distance between the four UAVs 10A, 10B, 10C, and 10D is maintained at D1=D2 and D3=D4. Also in this control, D1 and D2 may be fluctuated or D3 and D4 may be fluctuated, assuming that D1=D2 and D3=D4 are maintained.

Supplementary Notes: The present disclosure is grasped as follows.

### Supplementary Note 1

The collection method according to the present disclosure collects a target object (100) falling through the air by using an unmanned aerial vehicle (10).

The collection method according to the present disclosure includes: an information transmission step of transmitting state information (SI) of a target object (100) falling through the air from the target object (100); and
a collection step of capturing the target object (100) by an unmanned aerial vehicle (10) flying in accordance with command information (CI) generated based on the state information (SI).

### Supplementary Note 2

In the information transmission step according to Supplementary Note 1,
the state information (SI) preferably includes
position state information (PS) of the target object relative to the ground, and
velocity state information (VS) of the target object relative to the ground.

### Supplementary Note 3

In the information transmission step according to Supplementary Note 1or 2,
a state information generation unit (30) provided in the target object (100) can generate the position state information (PS) and the velocity state information (VS) based on radio waves received from a GPS satellite.

### Supplementary Note 4

In the collection step in any of Supplementary Notes 1 to 3, preferably,
the command information (CI) includes
position command information (xyz_{CI}) for the unmanned aerial vehicle (10) relative to the ground,
speed command information (vxyz_{CI}) for the unmanned aerial vehicle (10) relative to the ground, and
acceleration command information (axyz_{CI}) for the unmanned aerial vehicle (10) relative to the ground.

### Supplementary Note 5

In the collection step in any of Supplementary Notes 1 to 4, preferably,
the target object (100) is captured by a capture tool (15) supported by the unmanned aerial vehicle (10).

### Supplementary Note 6

In the collection step according to Supplementary Note 5, preferably,
the target object (100) is captured by the capture tool (15) having a net shape and supported by a plurality of unmanned aerial vehicles (10).

### Supplementary Note 7

In the collection step according to Supplementary Note 1, preferably,
flight of the plurality of unmanned aerial vehicles (10) is controlled such that relative positions of the plurality of unmanned aerial vehicles (10) with respect to the capture tools (15) are at a fixed distance from each other.

### Supplementary Note 8

In the collection step according to Supplementary Note 7, preferably,
flight of the plurality of unmanned aerial vehicles (10) is controlled such that the respective distances between the plurality of unmanned aerial vehicles (10) holding the capture tool (15) are at a fixed distance from each other.

### Supplementary Note 9

In the collection step according to any of Supplementary Notes 1 to 7, preferably, the target object falling through the air is supported by a parachute.

### Supplementary Note 10

A collection system that collects a target object falling through the air by using an unmanned aerial vehicle (10), the system including:
a state information generation unit provided in the target object and configured to generate and transmit state information SI of the target object; and
a controller provided in the unmanned aerial vehicle and configured to generate command information based on the state information SI and control flight of the unmanned aerial vehicle.

Besides the above-described embodiment, configurations explained in the above-described embodiment can be selected or omitted or can be changed to other configurations as necessary.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A collection method of collecting a target object falling through the air by using an unmanned aerial vehicle, the method comprising:
an information transmission step of transmitting state information of the target object falling through the air from the target object; and
a collection step of capturing the target object by the unmanned aerial vehicle flying in accordance with command information generated based on the state information.

2. The collection method according to claim 1, wherein
in the information transmission step,
the state information includes
position state information of the target object relative to the ground, and
velocity state information of the target object relative to the ground.

3. The collection method according to claim 2, wherein
in the information transmission step,
a state information generation unit provided in the target object generates the position state information and the velocity state information based on radio waves received from a satellite positioning system.

4. The collection method according to claim 1, wherein
in the collection step,
the command information includes
position command information for the unmanned aerial vehicle relative to the ground,
speed command information for the unmanned aerial vehicle relative to the ground, and
acceleration command information for the unmanned aerial vehicle relative to the ground.

5. The collection method according to claim 1, wherein
in the collection step,
the target object is captured by a capture tool supported by the unmanned aerial vehicle.

6. The collection method according to claim 5, wherein
in the collection step,
the target object is captured by the capture tool having a net shape and supported by a plurality of the unmanned aerial vehicles.

7. The collection method according to claim 1, wherein
in the collection step,
flight of the plurality of unmanned aerial vehicles is controlled such that relative positions of the plurality of unmanned aerial vehicles with respect to the target object are at a fixed distance from each other.

8. The collection method according to claim 7, wherein
in the collection step,
flight of the plurality of unmanned aerial vehicles is controlled such that respective distances between the plurality of unmanned aerial vehicles are maintained at a fixed distance from each other.

9. The collection method according to claim 1, wherein the target object falling through the air is supported by a parachute.

10. A collection system that collects a target object falling through the air by using an unmanned aerial vehicle, the system comprising:
a state information generation unit provided in the target object and configured to generate and transmit state information of the target object; and
a controller provided in the unmanned aerial vehicle and configured to generate command information based on the state information and control flight of the unmanned aerial vehicle.
